(19) United States
(12) Patent Application Publication
(10) Pub. No.: US 2017/0150548 A1
(43) Pub. Date: May 25, 2017

(54) TECHNIQUES FOR CARRIER DEACTIVATION IN WIRELESS COMMUNICATIONS

(71) Applicant: QUALCOMM Incorporated, San Diego, CA (US)

(72) Inventors: Chintan Shirish SHAH, Chula Vista, CA (US); Prasad KADIRI, San Diego, CA (US); Heechoon LEE, San Diego, CA (US); Kiran PATIL, San Diego, CA (US); Muhammed SARWAR, Poway, CA (US); Muhammad JAVED, Escondido, CA (US)

(21) Appl. No.: 15/294,416

(22) Filed: Oct. 14, 2016

Related U.S. Application Data
(60) Provisional application No. 62/257,598, filed on Nov. 19, 2015.

(51) Int. Cl. H04W 76/06; H04L 12/26; H04W 76/04

(52) U.S. Cl. CPC H04W 76/068; H04W 76/046; H04L 43/16

(57) ABSTRACT

Various aspects described herein relate to a user equipment (UE) that can receive a configuration for a radio bearer with an SCell in a radio resource control (RRC) reconfiguration procedure initiated by a primary cell (PCell) serving the UE. A component carrier with the SCell can be activated based at least in part on receiving a control element indicating to activate the component carrier for the radio bearer. It can be determined whether a first deactivation timer, for deactivating the component carrier with the SCell after a period of detected inactivity on the SCell, is configured by the PCell. A second deactivation timer can be configured for deactivating the component carrier with the SCell based at least in part on a determination that the first deactivation timer is not configured by the PCell or that a first configured duration of the first deactivation timer achieves a threshold.

### CLAIM OF PRIORITY UNDER 35 U.S.C. §119

The present application for patent claims priority to Provisional Application No. 62/257,598 entitled “TECHNIQUES FOR CARRIER DEACTIVATION IN WIRELESS COMMUNICATIONS” filed Nov. 19, 2015, which is assigned to the assignee hereof and hereby expressly incorporated by reference herein for all purposes.

### BACKGROUND

Described herein are aspects generally related to communication systems, and more particularly, to deactivating carriers in carrier aggregation.

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of a telecommunication standard is Long Term Evolution (LTE). LTE is a set of enhancements to the Universal Mobile Telecommunications System (UMTS) mobile standard promulgated by Third Generation Partnership Project (3GPP). It is designed to better support mobile broadband Internet access by improving spectral efficiency, lower costs, improve services, make use of new spectrum, and better integrate with other open standards using OFDMA on the downlink (DL), SC-FDMA on the uplink (UL), and multiple-input multiple-output (MIMO) antenna technology. However, as the demand for mobile broadband access continues to increase, further improvements in LTE technology may be desired. Preferably, these improvements should be applicable to other multi-access technologies and the telecommunication standards that employ these technologies.

LTE supports carrier aggregation (CA) where a user equipment (UE) can communicate with one or more cells using a plurality of aggregated component carriers (CCs) to improve efficiency in receiving/transmitting wireless communications. In CA, the UE can establish an initial connection with a primary cell (PCell) for communicating in a wireless network. The PCell can then configure one or more additional radio bearers for the UE to support additional CCs with one or more secondary cells (SCell). Instructions to activate and/or deactivate an additional aggregated CC with an SCell over an additional radio bearer may be received from the SCell itself.

In addition, it is possible that the UE is configured with opportunities to tune away radio resources from the PCell to for various purposes, such as to receive pages or other incoming signals for other radio access technologies, to measure other cells (e.g., cells of the same or other radio access technologies) in evaluating the other cells for handover/reselection, to perform interference cancellation, etc. The PCell may know of these opportunities (and may configure the UE with the opportunities), and may thus avoid communicating with the UE during these opportunities. The SCell, however, may not know of these opportunities configured in the UE. Accordingly, it is possible that the UE misses an SCell deactivation command sent by the SCell while the UE is tuned away. A UE may also miss an SCell deactivation command due to poor radio conditions with the SCell

Additionally, LTE radio access functionality has been extended into unlicensed frequency spectrums, such as the Unlicensed National Information Infrastructure (U-NII) band used by Wireless Local Area Network (WLAN) technologies. This extension of cell LTE operation is designed to increase spectral efficiency and hence coverage and capacity of the LTE system, and is often provided by small cells. Examples of technologies that provide LTE functionality over WLAN technologies include LTE in an unlicensed spectrum (LTE-U). When using such technologies, a carrier sense adaptive transmission (CSAT) cycle can be defined for applying adaptive time division multiplexing transmission over the unlicensed spectrum based on a determined medium utilization. A CSAT ON period can be defined in a CSAT cycle where a UE can monitor control channels, search for cells, report channel state information, etc., as well as a CSAT OFF period during which the UE can suspend radio resources to conserve power. When an SCell operates using LTE-U and the UE misses an SCell deactivation command from the SCell, the UE may remain in a CSAT ON period even though the SCell is deactivated, which may result in unnecessary power consumption at the UE.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

According to an example, a method for deactivating a secondary cell (SCell) in carrier aggregation is provided. The method includes receiving, by a user equipment (UE) a configuration for a radio bearer with an SCell in a radio resource control (RRC) reconfiguration procedure initiated by a primary cell (PCell) serving the UE, activating a component carrier with the SCell based at least in part on receiving a control element indicating to activate the component carrier for the radio bearer, and determining whether a first deactivation timer, for deactivating the component carrier with the SCell after a period of detected inactivity on the SCell, is configured by the PCell. The method further includes configuring a second deactivation timer for deactivating the component carrier with the SCell based at least in part on at least one of a first determination that the first deactivation timer is not configured by the PCell, or a second determination that a first configured duration of the first deactivation timer achieves a threshold, and deactivating the component carrier with the SCell based at least in part on detecting an expiration of the second deactivation timer before detecting communication related to the SCell.

The method may additionally include determining a second configured duration for the second deactivation timer based at least in part on a configuration stored at the UE, wherein configuring the second deactivation timer is based on the second configured duration. Also, the method may include receiving the first configured duration of the first deactivation timer from the PCell. Further, the method may include adding an offset value to the first configured duration of the first deactivation timer for the second determination that the first deactivation timer achieves the threshold, wherein the offset value compensates for a network detecting the SCell is in discontinuous transmit mode based on not receiving feedback from the UE for SCell transmissions. The method may also include determining the offset value based at least in part on a configuration stored at the UE. Additionally, the method may include wherein the threshold corresponds to a second configured duration of the second deactivation timer. The method may also include setting a second configured duration of the second deactivation timer to a default value configured at the UE based at least in part on determining that the second configured duration for the second deactivation timer is not configured at the UE.

In another aspect, an apparatus for deactivating a SCell in carrier aggregation is provided. The apparatus includes a transceiver for communicating one or more wireless signals over one or more antennas, at least one processor communicatively coupled with the transceiver, via a bus, for communicating the one or more wireless signals, and a memory communicatively coupled with the at least one processor and/or the transceiver via the bus. The at least one processor is configured to receive a configuration for a radio bearer with an SCell in a RRC reconfiguration procedure initiated by a PCell, activate a component carrier with the SCell based at least in part on receiving a control element indicating to activate the component carrier for the radio bearer, and determine whether a first deactivation timer, for deactivating the component carrier with the SCell after a period of detected inactivity on the SCell, is configured by the PCell. The at least one processor is further configured to configure a second deactivation timer for deactivating the component carrier with the SCell based at least in part on at least one of a first determination that the first deactivation timer is not configured by the PCell or a second determination that a first configured duration of the first deactivation timer achieves a threshold, and deactivate the component carrier with the SCell based at least in part on an detecting expiration of the second deactivation timer before detecting communication related to the SCell.

The apparatus may also include wherein the at least one processor is further configured to determine a second configured duration for the second deactivation timer based at least in part on a configuration, wherein the at least one processor is configured to configure the second deactivation timer is based on the second configured duration. The apparatus may further include wherein the at least one processor is further configured to receive the first configured duration of the first deactivation timer from the PCell. Additionally, the apparatus may include wherein the at least one processor is further configured to add an offset value to the first configured duration of the first deactivation timer for the second determination that the first deactivation timer achieves the threshold, wherein the offset value compensates for a network detecting the SCell is in discontinuous transmit mode based on not receiving feedback for SCell transmissions. The apparatus may also include wherein the at least one processor is further configured to determine the offset value based at least in part on a stored configuration. Further, the apparatus may include wherein the threshold corresponds to a second configured duration of the second deactivation timer. The apparatus may also include wherein the at least one processor is further configured to set a second configured duration of the second deactivation timer to a default value based at least in part on determining that the second configured duration for the second deactivation timer is not configured.

In another aspect, an apparatus for deactivating a SCell in carrier aggregation is provided. The apparatus may include means for receiving a configuration for a radio bearer with an SCell in a RRC reconfiguration procedure initiated by a PCell, means for activating a component carrier with the SCell based at least in part on receiving a control element indicating to activate the component carrier for the radio bearer, means for determining whether a first deactivation timer, for deactivating the component carrier with the SCell after a period of detected inactivity on the SCell, is configured by the PCell, means for configuring a second deactivation timer for deactivating the component carrier with the SCell based at least in part on at least one of a first determination that the first deactivation timer is not configured by the PCell or a second determination that a first configured duration of the first deactivation timer achieves a threshold, and means for deactivating the component carrier with the SCell based at least in part on detecting an expiration of the second deactivation timer before detecting communication related to the SCell.

The apparatus may also include means for determining a second configured duration for the second deactivation timer based at least in part on a configuration, wherein the means for configuring configures the second deactivation timer is based on the second configured duration. The apparatus may also include means for receiving the first configured duration of the first deactivation timer from the PCell. The apparatus may also include means for adding an offset value to the first configured duration of the first deactivation timer for the second determination that the first deactivation timer achieves the threshold, wherein the offset value compensates for a network detecting the SCell is in discontinuous transmit mode based on not receiving feedback for SCell transmissions. The apparatus may also include means for determining the offset value based at least in part on a stored configuration. Further, the apparatus may include wherein the threshold corresponds to a second configured duration of the second deactivation timer. The apparatus may also include means for setting a second configured duration of the second deactivation timer to a default value configured based at least in part on determining that the second configured duration for the second deactivation timer is not configured.

In still another aspect, a computer-readable storage medium including computer executable code for deactivating a secondary cell (SCell) in carrier aggregation is provided. The code includes code for receiving, by a UE a configuration for a radio bearer with an SCell in a RRC reconfiguration procedure initiated by a PCell serving the UE, code for activating a component carrier with the SCell based at least in part on receiving a control element indicating to activate the component carrier for the radio bearer; and code for determining whether a first deactivation timer, for deactivating the component carrier with the SCell after a period of detected inactivity on the SCell, is configured by the PCell. The code further includes code for configuring a second deactivation timer for deactivating the component carrier with the SCell based at least in part on at least one of a first determination that the first deactivation timer is not configured by the PCell or a second determination that a first configured duration of the first deactivation timer achieves a threshold, and code for deactivating the component carrier with the SCell based at least in part on detecting an expiration of the second deactivation timer before detecting communication related to the SCell.

The computer-readable storage medium may also include code for determining a second configured duration for the second deactivation timer based at least in part on a configuration stored at the UE, wherein the code for configuring configures the second deactivation timer is based on the second configured duration. The computer-readable storage medium may also include code for receiving the first configured duration of the first deactivation timer from the PCell. The computer-readable storage medium may further include code for adding an offset value to the first configured duration of the first deactivation timer for the second determination that the first deactivation timer achieves the threshold, wherein the offset value compensates for a network detecting the SCell is in discontinuous transmit mode based on not receiving feedback from the UE for SCell transmissions. Additionally the computer-readable storage medium may include code for determining the offset value based at least in part on a configuration stored at the UE. The computer-readable storage medium may also include wherein the threshold corresponds to a second configured duration of the second deactivation timer. The computer-readable storage medium may additionally include code for setting a second configured duration of the second deactivation timer to a default value configured at the UE based at least in part on determining that the second configured duration for the second deactivation timer is not configured at the UE.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

In order to facilitate a fuller understanding of aspects described herein, reference is now made to the accompanying drawings, in which like elements are referenced with like numerals. These drawings should not be construed as limiting the present disclosure, but are intended to be illustrative only.

FIG. 1 shows a block diagram conceptually illustrating an example of a telecommunications system, in accordance with aspects described herein.

FIG. 2 is a diagram illustrating an example of an access network, in accordance with aspects described herein.

FIG. 3 is a diagram illustrating an example of an evolved Node B and user equipment in an access network, in accordance with aspects described herein.

FIG. 4 is a diagram illustrating an example of a system for configuring a deactivation timer for deactivating a component carrier of a secondary cell in accordance with aspects described herein.

FIG. 5 is a flow chart of an example of a method for configuring a deactivation timer for deactivating a component carrier of a secondary cell in accordance with aspects described herein.

FIG. 6 illustrates examples of timelines for contemporaneously communicating with a primary cell and a secondary cell in accordance with aspects described herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more aspects, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), and floppy disk where disks usually reproduce data magnetically, while discs reproduce data optically with lasers. Combinations of the above should also be included within the scope of computer-readable media.

Described herein are various aspects related to deactivating component carriers (CC) in carrier aggregation (CA) in wireless communications. In certain CA configurations, a user equipment (UE) may miss a deactivation command sent from a secondary cell (SCell), which can result in a user equipment (UE) remaining in a powered on state with respect to the SCell though the SCell may not be transmitting to the UE. For example, this may occur where the UE is tuned away from the SCell based on a procedure configured by the PCell (or other cell), where the UE is in poor radio conditions with the SCell, etc. This may also occur, for example, where the CC of the SCell corresponds to a radio access technology (RAT) that uses an adaptive transmission cycle based on a detected medium utilization. In this example, the UE may miss the deactivation command sent from the SCell and may accordingly remain in an ON state of the adaptive transmission cycle, where the UE monitors a control channel for control data from the SCell even though the SCell has deactivated the carrier. Accordingly, as described by the present aspects, the UE can configure a new deactivation timer for deactivating the CC related to the SCell after detecting a period of inactivity over the CC. This new deactivation timer may be an alternative deactivation timer configured by the UE that is in addition to, and has a shorter configured duration than, a first deactivation timer, configured for the SCell (e.g., by the primary cell (PCell). In particular, the present aspects enable the UE to include this new, alternative deactivation timer when the first deactivation timer is configured to have a duration that is of at least a threshold duration, such as an amount of time after which further consumption of resources by the UE is not desired. As such, in some cases, the present aspects configure a UE to utilize a new SCell deactivation timer (e.g., the alternative deactivation timer) configured with a smaller duration relative to a typical deactivation timer (e.g., an initial or first deactivation timer configured by the PCell) to result in less unnecessary consumption of resources at the UE. In addition, for example, where a deactivation timer is not configured, the new, alternative deactivation timer can be used to determine to deactivate the SCell CC after a period of inactivity.

In a specific example, in third generation partnership project (3GPP) long term evolution (LTE), a SCell can be configured using LTE over an unlicensed spectrum (LTE-U), which can define a carrier sense adaptive transmission (CSAT) cycle having an ON period during which a UE monitors a control channel, measures cells, reports channel state information (CSI), etc. (also referred to as CSAT ON), and an OFF period during which the UE can suspend communication resources to conserve power (also referred to as CSAT OFF). The duration of the CSAT ON period and CSAT OFF period can be defined based on a detected medium utilization. For example, LTE-U can use similar operating frequencies as other RATs, such as Institute of Electrical and Electronics Engineers (IEEE) 802.11 (Wi-Fi), licensed assisted access (e.g., as defined in Release 13 of LTE), etc. For example, a UE and/or eNB can detect medium utilization by other devices (e.g., Wi-Fi, LAA, and/or other LTE-U devices) and can accordingly determine the CSAT cycle (e.g., durations for the CSAT ON and CSAT OFF periods) for the UE to utilize in communicating using LTE-U such to minimize potential interference with the other devices.

In this specific example, the UE may tune away from the SCell for a period of time based on a configuration received from the PCell or otherwise stored in the UE (e.g., to measure other cells for handover, perform interference cancellation, etc.), during which the UE may miss a deactivation command from the SCell to deactivate the corresponding CC. After the tune away, the UE may consider the SCell as active based on not receiving the command, and may continue to operate according to a CSAT ON period, which may result in unnecessary consumption of resources based on the SCell deactivating the CC. In another example, the UE may miss the deactivation command from the SCell due to poor radio conditions in communicating with the SCell (e.g., the UE may not receive or may not be able to properly decode the deactivation command), and can remain in the CSAT ON period. Thus, the UE can configure the deactivation timer to deactivate the CC with the SCell after a detected period of inactivity. This can be an alternative timer to an initial deactivation timer configured for the UE by the PCell for deactivating the SCell, where the initial deactivation timer is of a configured duration that achieves a threshold, which may be larger than a configured duration of the alternative timer or otherwise of an undesirably long duration (such that using a smaller duration timer can be determined to result in less unnecessary consumption of resources at the UE).

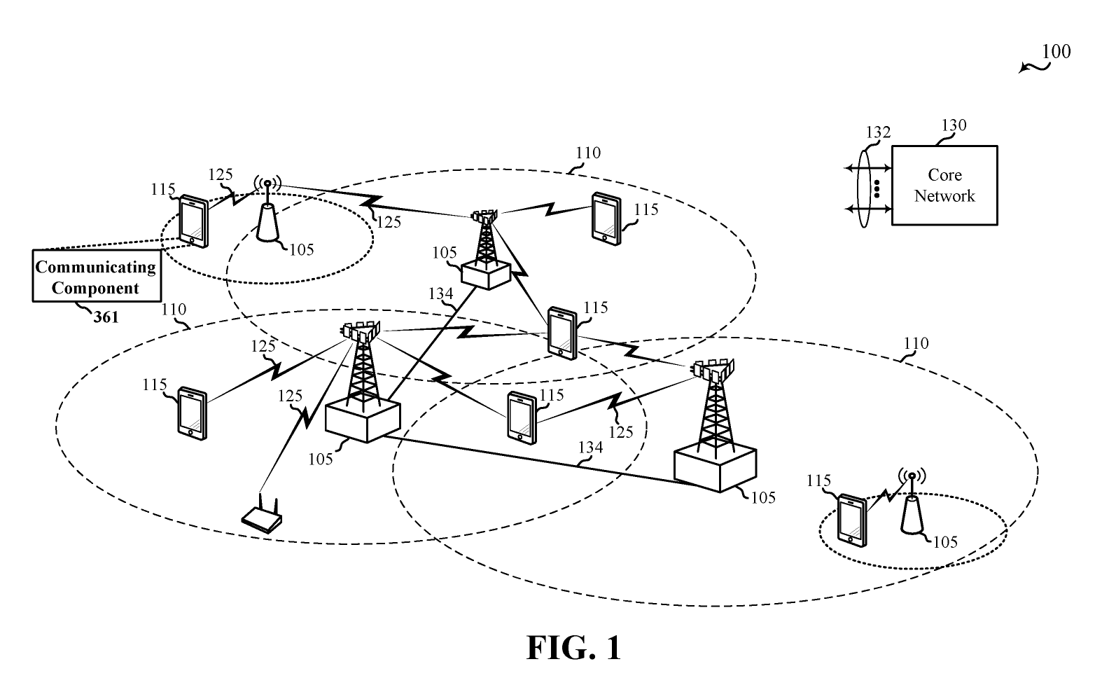

Referring first to FIG. 1, a diagram illustrates an example of a wireless communications system 100, in accordance with aspects described herein. The wireless communications system 100 includes a plurality of access points (e.g., base stations, eNBs, or WLAN access points) 105, a number of user equipment (UEs) 115, and a core network 130. One or more of UEs 115 may include a communicating component 361 configured to utilize one or more deactivation timers for deactivating one or more CCs in CA. Some of the access points 105 may communicate with the UEs 115 under the control of a base station controller (not shown), which may be part of the core network 130 or the certain access points 105 (e.g., base stations or eNBs) in various examples. Access points 105 may communicate control information and/or user data with the core network 130 through backhaul links 132. In examples, the access points 105 may communicate, either directly or indirectly, with each other over backhaul links 134, which may be wired or wireless communication links. The wireless communications system 100 may support operation on multiple carriers (waveform signals of different frequencies). Multi-carrier transmitters can transmit modulated signals simultaneously on the multiple carriers. For example, each communication link 125 may be a multi-carrier signal modulated according to the various radio technologies described above. Each modulated signal may be sent on a different carrier and may carry control information (e.g., reference signals, control channels, etc.), overhead information, data, etc.

The access points 105 may wirelessly communicate with the UEs 115 via one or more access point antennas. Each of the access points 105 sites may provide communication coverage for a respective coverage area 110. In some examples, access points 105 may be referred to as a base transceiver station, a radio base station, a radio transceiver, a basic service set (BSS), an extended service set (ESS), a NodeB, eNodeB, Home NodeB, a Home eNodeB, or some other suitable terminology. The coverage area 110 for a base station may be divided into sectors making up only a portion of the coverage area (not shown). The wireless communications system 100 may include access points 105 of different types (e.g., macro, micro, and/or pico base stations). The access points 105 may also utilize different radio technologies, such as cellular and/or WLAN radio access technologies (RAT). The access points 105 may be associated with the same or different access networks or operator deployments. The coverage areas of different access points 105, including the coverage areas of the same or different types of access points 105, utilizing the same or different radio technologies, and/or belonging to the same or different access networks, may overlap.

In network communication systems using LTE/LTE-A/LTE-U communication technologies, the terms evolved Node B (eNodeB or eNB) may be generally used to describe the access points 105. The wireless communications system 100 may be a Heterogeneous LTE/LTE-A/LTE-U network in which different types of access points provide coverage for various geographical regions. For example, each access point 105 may provide communication coverage for a macro cell, a pico cell, a femto cell, and/or other types of cell. Small cells such as pico cells, femto cells, and/or other types of cells may include low power nodes or LPNs. A macro cell may cover a relatively large geographic area (e.g., several kilometers in radius) and may allow unrestricted access by UEs 115 with service subscriptions with the network provider. A small cell may cover a relatively smaller geographic area and may allow unrestricted access by UEs 115 with service subscriptions with the network provider, for example, and in addition to unrestricted access, may also provide restricted access by UEs 115 having an association with the small cell (e.g., UEs in a closed subscriber group (CSG), UEs for users in the home, and the like). An eNB for a macro cell may be referred to as a macro eNB. An eNB for a small cell may be referred to as a small cell eNB. An eNB may support one or multiple (e.g., two, three, four, and the like) cells.

The core network 130 may communicate with the eNBs or other access points 105 via one or more backhaul links 132 (e.g., S1 interface, etc.). The access points 105 may also communicate with one another, e.g., directly or indirectly via backhaul links 134 (e.g., X2 interface, etc.) and/or via backhaul links 132 (e.g., through core network 130). The wireless communications system 100 may support synchronous or asynchronous operation. For synchronous operation, the access points 105 may have similar frame timing, and transmissions from different access points 105 may be approximately aligned in time. For asynchronous operation, the access points 105 may have different frame timing, and transmissions from different access points 105 may not be aligned in time. The techniques described herein may be used for either synchronous or asynchronous operations.

The UEs 115 are dispersed throughout the wireless communications system 100, and each UE 115 may be stationary or mobile. A UE 115 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. A UE 115 may be a cellular phone, a personal digital assistant (PDA), a wireless modem, a wireless communication device, a handheld device, a tablet computer, a laptop computer, a cordless phone, a wearable item such as a watch or glasses, a wireless local loop (WLL) station, or the like. A UE 115 may be able to communicate with macro eNodeBs, small cell eNodeBs, relays, and the like. A UE 115 may also be able to communicate over different access networks, such as cellular or other WWAN access networks, or WLAN access networks.

The communication links 125 shown in wireless communications system 100 may include uplink (UL) transmissions from a UE 115 to an access point 105, and/or downlink (DL) transmissions, from an access point 105 to a UE 115. The downlink transmissions may also be called forward link transmissions while the uplink transmissions may also be called reverse link transmissions. The communication links 125 may carry transmissions of one or more hierarchical layers which, in some examples, may be multiplexed in the communication links 125. The UEs 115 may be configured to collaboratively communicate with multiple access points 105 through, for example, Multiple Input Multiple Output (MIMO), carrier aggregation (CA), Coordinated Multi-Point (CoMP), or other schemes. MIMO techniques use multiple antennas on the access points 105 and/or multiple antennas on the UEs 115 to transmit multiple data streams. Carrier aggregation may utilize two or more component carriers on a same or different serving cell for data transmission. CoMP may include techniques for coordination of transmission and reception by a number of access points 105 to improve overall transmission quality for UEs 115 as well as increasing network and spectrum utilization.

As mentioned, in some examples access points 105 and UEs 115 may utilize carrier aggregation to transmit on multiple carriers. In some examples, access points 105 and UEs 115 may concurrently communicate using two or more separate carriers. Each carrier may have a bandwidth of, for example, 20 MHz, although other bandwidths may be utilized. Each of the different operating modes that may be employed by wireless communications system 100 may operate according to frequency division duplexing (FDD) or time division duplexing (TDD). In some examples, different CCs may operate according to different TDD or FDD modes, using different RATs, etc. For example, a UE 115 may communicate with a cell of an access point 105 over a CC using LTE, and the cell may also configure UE 115 to communicate with another cell (e.g., a cell of the same or different access point) over a CC using LTE-U. In an example, an access point 105 can configure a UE 115 with a PCell, which can include a CC for configuring additional cells or related CCs, such as an SCell provided by the access point 105 or another access point. The UE 115 can communicate with the PCell and/or SCell (and/or related access point(s) 105) based on the CA configuration received from the PCell.

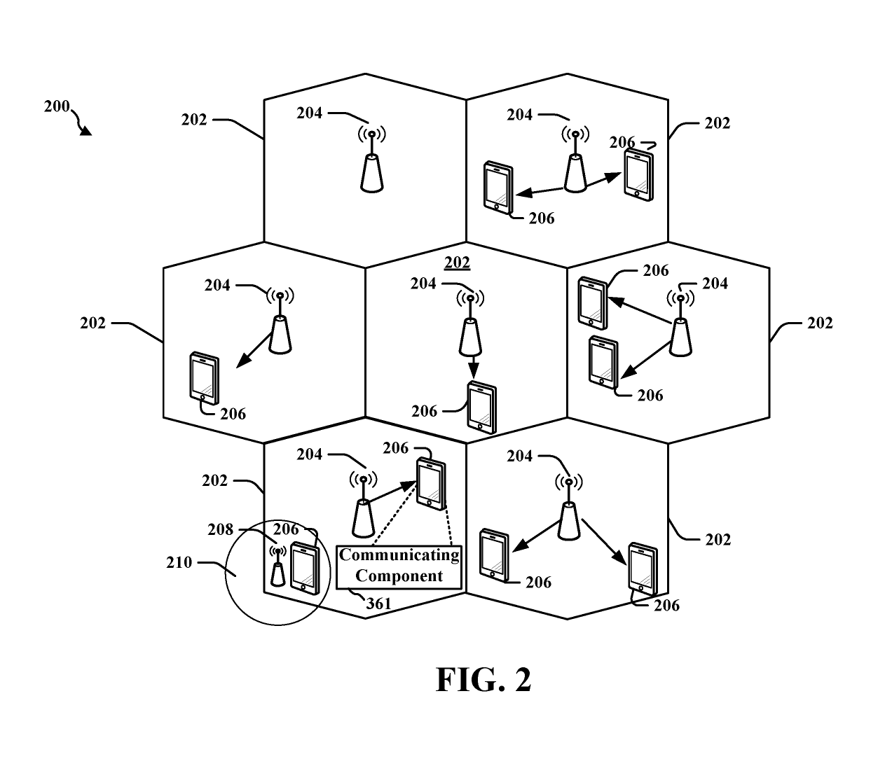

FIG. 2 is a diagram illustrating an example of an access network 200 in an LTE network architecture. In this example, the access network 200 is divided into a number of cellular regions (cells) 202. One or more small cell eNBs 208 may have cellular regions 210 that overlap with one or more of the cells 202. The small cell eNBs 208 may provide one or more cells of a lower power class, such as a femto cell (e.g., home eNB (HeNB)), pico cell, micro cell, or remote radio head (RRH). The macro eNBs 204 are each assigned to a respective cell 202 and are configured to provide an access point to the core network 130 for all the UEs 206 in the cells 202. In an aspect, one or more of UEs 206 may include a communicating component 361 configured to utilize one or more deactivation timers for deactivating one or more CCs in CA. For example, one or more eNBs 204/208 may communicate with UE 206 to provide network access thereto (e.g., as a PCell) and may configure a radio bearer for the UE 206 to communicate with one or more additional cells (e.g., SCells) provided by the eNB 204/208 or another eNB 204/208 over one or more other CCs. For example, the one or more deactivation timers may correspond to deactivating the one or more other CCs. There is no centralized controller in this example of an access network 200, but a centralized controller may be used in alternative configurations. The eNBs 204 are responsible for all radio related functions including radio bearer control, admission control, mobility control, scheduling, security, and connectivity to one or more components of core network 130.

The modulation and multiple access scheme employed by the access network 200 may vary depending on the particular telecommunications standard being deployed. In LTE or ULL LTE applications, OFDM may be used on the DL and SC-FDMA may be used on the UL to support both frequency division duplexing (FDD) and time division duplexing (TDD). As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), IEEE 802.11 (Wi-Fi), IEEE 802.16 (WiMAX), IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The eNBs 204 may have multiple antennas supporting MIMO technology. The use of MIMO technology enables the eNBs 204 to exploit the spatial domain to support spatial multiplexing, beamforming, and transmit diversity. Spatial multiplexing may be used to transmit different streams of data simultaneously on the same frequency. The data steams may be transmitted to a single UE 206 to increase the data rate or to multiple UEs 206 to increase the overall system capacity. This is achieved by spatially precoding each data stream (i.e., applying a scaling of an amplitude and a phase) and then transmitting each spatially precoded stream through multiple transmit antennas on the DL. The spatially precoded data streams arrive at the UE(s) 206 with different spatial signatures, which enables each of the UE(s) 206 to recover the one or more data streams destined for that UE 206. On the UL, each UE 206 transmits a spatially precoded data stream, which enables the eNB 204 to identify the source of each spatially precoded data stream.

Spatial multiplexing is generally used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

In the detailed description that follows, various aspects of an access network will be described with reference to a MIMO system supporting OFDM on the DL. OFDM is a spread-spectrum technique that modulates data over a number of subcarriers within an OFDM symbol. The subcarriers are spaced apart at precise frequencies. The spacing provides “orthogonality” that enables a receiver to recover the data from the subcarriers. In the time domain, a guard interval (e.g., cyclic prefix) may be added to each OFDM symbol to combat inter-OFDM-symbol interference. The UL may use SC-FDMA in the form of a DFT-spread OFDM signal to compensate for high peak-to-average power ratio (PAPR).

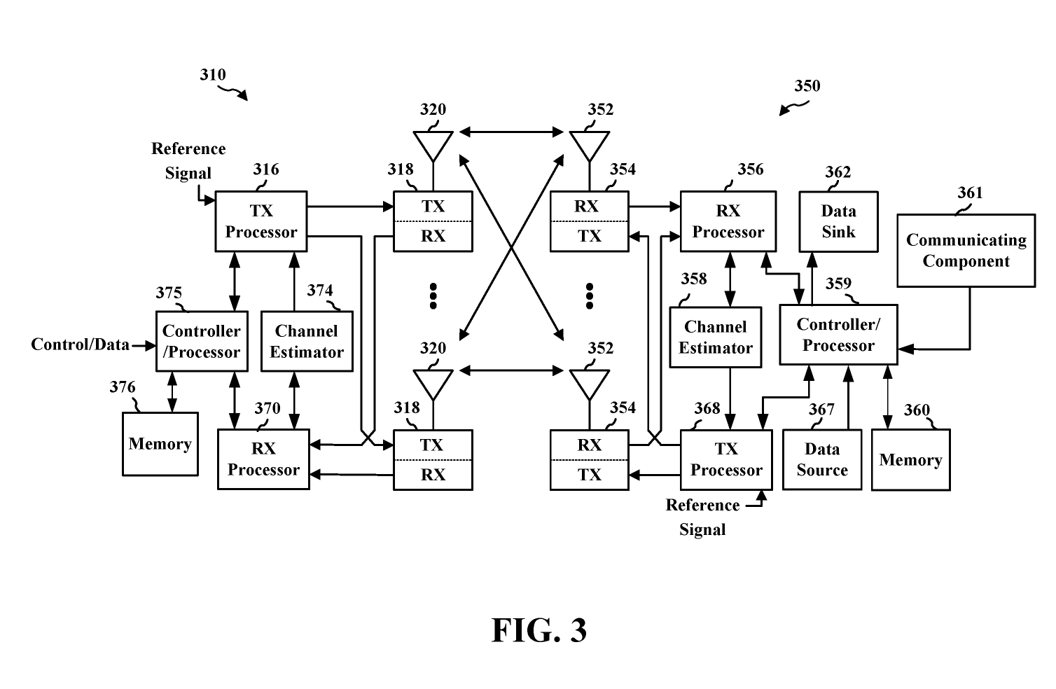

FIG. 3 is a block diagram of an eNB 310 in communication with a UE 350 in an access network, wherein UE 350 includes communicating component 361 configured to utilize one or more deactivation timers for deactivating one or more CCs in CA. In the DL, upper layer packets from the core network are provided to a controller/processor 375. The controller/processor 375 implements the functionality of the L2 layer. In the DL, the controller/processor 375 provides header compression, ciphering, packet segmentation and reordering, multiplexing between logical and transport channels, and radio resource allocations to the UE 350 based on various priority metrics. The controller/processor 375 is also responsible for HARQ operations, retransmission of lost packets, and signaling to the UE 350.

The transmit (TX) processor 316 implements various signal processing functions for the L1 layer (i.e., physical layer). The signal processing functions includes coding and interleaving to facilitate forward error correction (FEC) at the UE 350 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot signal) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream is then provided to a different antenna 320 via a separate transmitter 318TX. Each transmitter 318TX modulates an RF carrier with a respective spatial stream for transmission.

At the UE 350, each receiver 354RX receives a signal through its respective antenna 352. Each receiver 354RX recovers information modulated onto an RF carrier and provides the information to the receive (RX) processor 356. The RX processor 356 implements various signal processing functions of the L1 layer. The RX processor 356 performs spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, is recovered and demodulated by determining the most likely signal constellation points transmitted by the eNB 310. These soft decisions may be based on channel estimates computed by the channel estimator 358. The soft decisions are then decoded and deinterleaved to recover the data and control signals that were originally transmitted by the eNB 310 on the physical channel. The data and control signals are then provided to the controller/processor 359.

The controller/processor 359 implements the L2 layer. The controller/processor can be associated with a memory 360 that stores program codes and data. The memory 360 may be referred to as a computer-readable medium. In the UL, the controller/processor 359 provides demultiplexing between transport and logical channels, packet reassembly, deciphering, header decompression, control signal processing to recover upper layer packets from the core network. The upper layer packets are then provided to a data sink 362, which represents all the protocol layers above the L2 layer. Various control signals may also be provided to the data sink 362 for L3 processing. The controller/processor 359 is also responsible for error detection using an acknowledgement (ACK) and/or negative acknowledgement (NACK) protocol to support HARQ operations.

In addition, the UE 350 may include a communicating component 361 configured to utilize one or more deactivation timers for deactivating one or more CCs in CA. In an example, though communicating component 361 is shown as coupled with controller/processor 359, substantially any processor of a UE 350 can provide the functions of the communicating component 361 and/or its related components described herein (e.g., in conjunction with controller/processor 359, memory 360, or otherwise). For example, TX processor 368 and/or RX processor 356 can additionally or alternatively provide one or more functions of communicating component 361, as described herein.

In the UL, a data source 367 is used to provide upper layer packets to the controller/processor 359. The data source 367 represents all protocol layers above the L2 layer. Similar to the functionality described in connection with the DL transmission by the eNB 310, the controller/processor 359 implements the L2 layer for the user plane and the control plane by providing header compression, ciphering, packet segmentation and reordering, and multiplexing between logical and transport channels based on radio resource allocations by the eNB 310. The controller/processor 359 is also responsible for HARQ operations, retransmission of lost packets, and signaling to the eNB 310.

Channel estimates derived by a channel estimator 358 from a reference signal or feedback transmitted by the eNB 310 may be used by the TX processor 368 to select the appropriate coding and modulation schemes, and to facilitate spatial processing. The spatial streams generated by the TX processor 368 are provided to different antenna 352 via separate transmitters 354TX. Each transmitter 354TX modulates an RF carrier with a respective spatial stream for transmission.

The UL transmission is processed at the eNB 310 in a manner similar to that described in connection with the receiver function at the UE 350. Each receiver 318RX receives a signal through its respective antenna 320. Each receiver 318RX recovers information modulated onto an RF carrier and provides the information to a RX processor 370. The RX processor 370 may implement the L1 layer.

The controller/processor 375 implements the L2 layer. The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover upper layer packets from the UE 350. Upper layer packets from the controller/processor 375 may be provided to the core network. The controller/processor 375 is also responsible for error detection using an ACK and/or NACK protocol to support HARQ operations.

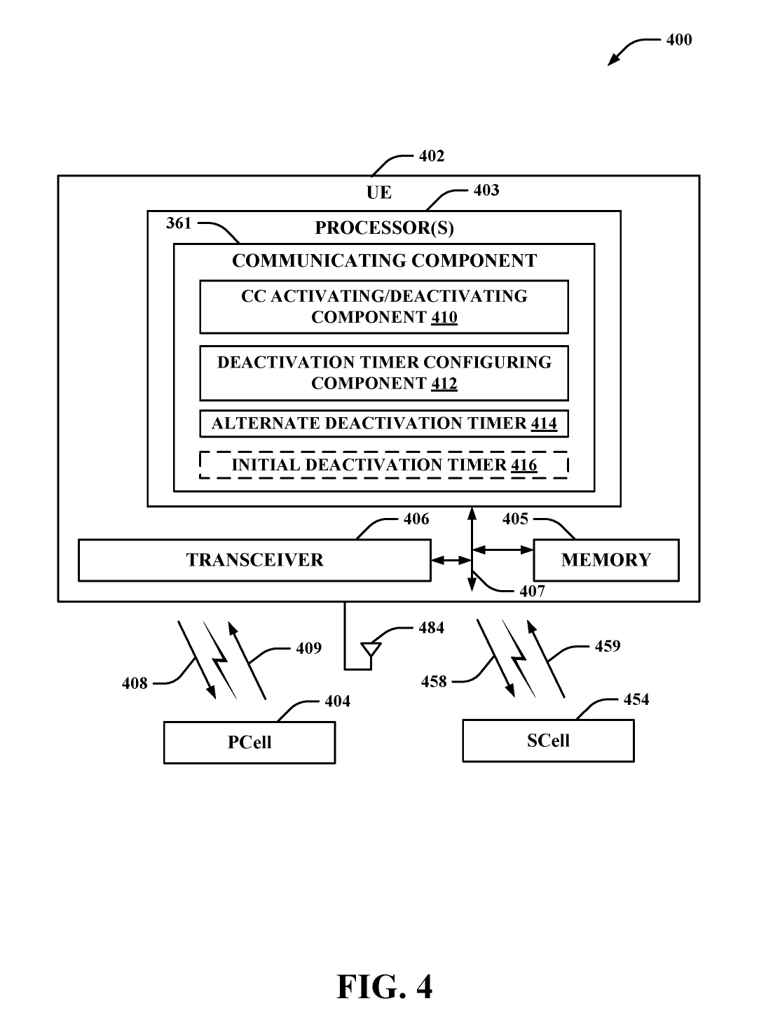

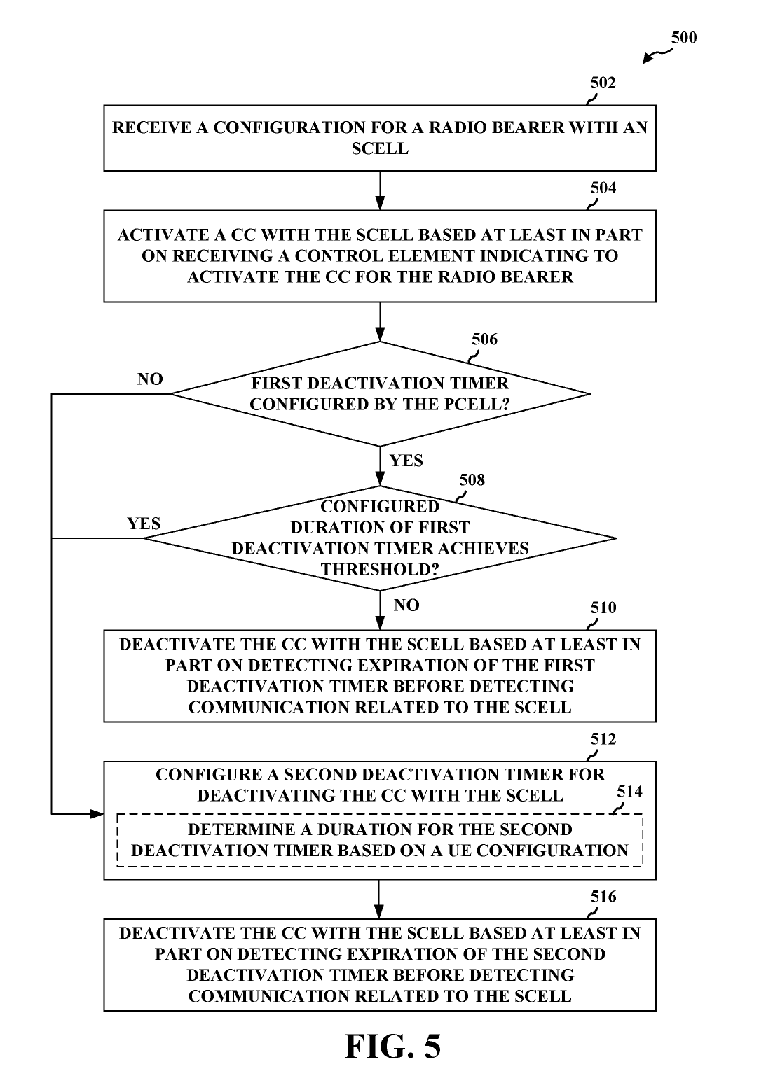

Referring to FIGS. 4-5, aspects are depicted with reference to one or more components and one or more methods that may perform the actions or functions described herein. In an aspect, the term “component” as used herein may be one of the parts that make up a system, may be hardware or software or some combination thereof, and may be divided into other components. Although the operations described below in FIG. 5 are presented in a particular order and/or as being performed by an example component, it should be understood that the ordering of the actions and the components performing the actions may be varied, depending on the implementation. Moreover, it should be understood that the following actions or functions may be performed by a specially-programmed processor, a processor executing specially-programmed software or computer-readable media, or by any other combination of a hardware component and/or a software component capable of performing the described actions or functions.

FIG. 4 illustrates an example of a system 400 for providing channels in ULL communications. System 400 includes a UE 402 that communicates with a PCell 404 to access a wireless network, examples of which are described in FIGS. 1-3 (e.g., access points 105, eNB 204, small cell eNB 208, eNB 310, or related cells, UEs 115, 206, 350, etc.), above. In an aspect, PCell 404 and UE 402 may have established one or more downlink channels over which to communicate via downlink signals 409, which can be transmitted by PCell 404 and received by UE 402 (e.g., via transceiver 406) for communicating control and/or data messages (e.g., in signaling) from the PCell 404 to the UE 402 over configured communication resources. Moreover, for example, PCell 404 and UE 402 may have established one or more uplink channels over which to communicate via uplink signals 408, which can be transmitted by UE 402 (e.g., via transceiver 406) and received by PCell 404 for communicating control and/or data messages (e.g., in signaling) from the UE 402 to the PCell 404 over configured communication resources.

In addition, in an example, PCell 404 can configure UE 402 to communicate with one or more SCells 454 along with PCell 404 in CA, where the SCell 454 may be provided by a same or different eNB as PCell 404. For example, PCell 404 can configure UE 402 to contemporaneously receive, via transceiver 406, communications from both PCell 404 and SCell 454, contemporaneously transmit, via transceiver 406, communications to both PCell 404 and SCell 454, etc. over multiple related CCs. In addition, UE 402 may be configured with opportunities to tune away the transceiver 406 from the PCell 404 and SCell 454 to receive incoming signals of other RATs, evaluate or otherwise measure neighboring cells, etc., as described, which may cause UE 402 to miss a CC deactivation command for the SCell 454. In another example, the UE 402 may miss a CC deactivation command for the SCell 454 due to poor or degraded radio conditions with the cell transmitting the CC deactivation command (e.g., PCell 404 or SCell 454). Accordingly, as described further herein, the UE 402 can maintain a deactivation timer for deactivating CC corresponding to the SCell after a detected period of inactivity over the CC corresponding to the SCell.

In a specific example, UE 402 can include one or more subscriber identity modules (SIM), which are not shown. Where UE 402 includes multiple SIMs that can each be configured for a subscription with one or more cells, the UE 402 may perform tune away from one wireless service (e.g., LTE) to one or more other wireless services (e.g., 1×round trip time (RTT), global system for mobile communications (GSM), time division synchronous code division multiple access (TD-SCDMA), etc.). This tune away to other technologies for monitoring any incoming pages and/or overhead message updates, may cause UE 402 to miss downlink (DL) and/or uplink (UL) grants, media access control (MAC)-control elements (CE) for SCell activation/deactivation, etc., which may be received from the SCell 454 (or PCell 404). In addition, the UE 402 may or may not be configured with an initial deactivation timer for deactivating communications with the SCell 454 (or PCell 404) after a period of detected in activity.

Where the UE 402 is not configured with the initial deactivation timer for deactivating communications with the SCell 454, if the UE 402 fails to receive the MAC-CE deactivation command at the end of CSAT ON period, the UE 402 may remain in CSAT ON Mode even though the SCell 454 is in CSAT OFF period. In CSAT OFF period, SCell 454 may not transmit cell-specific reference signal (CRS) and No DL SCell Data may be scheduled. Due to remaining in CSAT ON period, the UE 402 may otherwise continue to perform CSAT ON operations (e.g. SCell physical downlink control channel (PDCCH) monitoring, SCell searching operations, periodic channel state information (CSI) reporting, etc.). This can be inefficient SCell Operation and may impact the UE 402 SCell power efficiency. In yet another example, where the UE 402 is configured with the initial deactivation timer, the value of the timer may be undesirably long (e.g., 640 ms or 1280 ms). Accordingly, described herein are examples for improving SCell (e.g., LTE-U or other unlicensed SCell) deactivation mechanisms to improve power operation efficiency of the UE 402, to prevent loss of UE 402 to eNB synchronization (e.g., with PCell 404) during a CSAT operation (e.g., with SCell 454), to prevent UE 402 from getting stuck in false CSAT state when the UE 402 misses MAC-CE for deactivation, etc.

In an aspect, UE 402 may include one or more processors 403 and/or a memory 405 that may be communicatively coupled, e.g., via one or more buses 407, and may operate in conjunction with or otherwise implement communicating component 361 for utilizing one or more deactivation timers for deactivating one or more CCs in CA. For example, the various operations related to communicating component 361 may be implemented or otherwise executed by one or more processors 403 and, in an aspect, can be executed by a single processor, while in other aspects, different ones of the operations may be executed by a combination of two or more different processors. For example, in an aspect, the one or more processors 403 may include any one or any combination of a modem processor, or a baseband processor, or a digital signal processor, or an application specific integrated circuit (ASIC), or a transmit processor, receive processor, or a transceiver processor associated with transceiver 406. Further, for example, the memory 405 may be a non-transitory computer-readable medium that includes, but is not limited to, random access memory (RAM), read only memory (ROM), programmable ROM (PROM), erasable PROM (EPROM), electrically erasable PROM (EEPROM), a magnetic storage device (e.g., hard disk, floppy disk, magnetic strip), an optical disk (e.g., compact disk (CD), digital versatile disk (DVD)), a smart card, a flash memory device (e.g., card, stick, key drive), a register, a removable disk, and any other suitable medium for storing software and/or computer-readable code or instructions that may be accessed and read by a computer or one or more processors 403. Moreover, memory 405 or computer-readable storage medium may be resident in the one or more processors 403, external to the one or more processors 403, distributed across multiple entities including the one or more processors 403, etc.

In particular, the one or more processors 403 and/or memory 405 may execute actions or operations defined by communicating component 361 or its subcomponents. For instance, the one or more processors 403 and/or memory 405 may execute actions or operations defined by a CC activating/deactivating component 410 for activating and/or deactivating one or more CCs with one or more SCells in CA. In an aspect, for example, CC activating/deactivating component 410 may include hardware (e.g., one or more processor modules of the one or more processors 403) and/or computer-readable code or instructions stored in memory 405 and executable by at least one of the one or more processors 403 to perform the specially configured CC activating/deactivating operations described herein. Further, for instance, the one or more processors 403 and/or memory 405 may execute actions or operations defined by a deactivation timer configuring component 412 for configuring an alternate deactivation timer 414 (relative to an “initial” or “first” deactivation timer 416, described below), which may also be managed by the one or more processors 403 and/or memory 405, for deactivating the one or more CCs with the one or more SCells. In an aspect, for example, deactivation timer configuring component 412 may include hardware (e.g., one or more processor modules of the one or more processors 403) and/or computer-readable code or instructions stored in memory 405 and executable by at least one of the one or more processors 403 to perform the specially configured deactivation timer configuring operations described herein. Further, for instance, the one or more processors 403 and/or memory 405 may optionally execute actions or operations defined by an optional initial deactivation timer 416 that may be received in a configuration from the PCell 404. In an aspect, for example, initial deactivation timer 416 may be provided by hardware (e.g., one or more processor modules of the one or more processors 403) and/or computer-readable code or instructions stored in memory 405 and executable by at least one of the one or more processors 403 to perform the specially configured deactivation timing operations described herein.

In an example, transceiver 406 may be configured to transmit and receive wireless signals through one or more antennas 484 and may generate or process the signals using one or more RF front end components (e.g., power amplifiers, low noise amplifiers, filters, analog-to-digital converters, digital-to-analog converters, etc.), one or more transmitters, one or more receivers, etc. In an aspect, transceiver 406 may be tuned to operate at specified frequencies such that UE 402 can communicate at a certain frequency. In an aspect, the one or more processors 403 may configure transceiver 406 to operate at a specified frequency and power level based on a configuration, a communication protocol, etc. to communicate uplink signals 408 and/or downlink signals 409, respectively, over related uplink or downlink communication channels.

In an aspect, transceiver 406 can operate in multiple bands (e.g., using a multiband-multimode modem, not shown) such to process digital data sent and received using transceiver 406. In an aspect, transceiver 406 can be multiband and be configured to support multiple frequency bands for a specific communications protocol. In an aspect, transceiver 406 can be configured to support multiple operating networks and communications protocols. Thus, for example, transceiver 406 may enable transmission and/or reception of signals based on a specified modem configuration.

FIG. 5 illustrates an example of a method 500 for configuring (e.g., by a UE) a deactivation timer for deactivating one or more CCs in CA. Method 500 includes, at Block 502, receiving a configuration for a radio bearer with an SCell. In an aspect, communicating component 361, e.g., in conjunction with the one or more processors 403, memory 405, and/or transceiver 406, can receive the configuration for the radio bearer with the SCell 454. As described, for example, UE 402 can have established a connection with PCell 404 to receive access to a wireless network (e.g., via a random access procedure or other procedure to establish a radio bearer and associated CC with the PCell 404). In one example, PCell 404 can configure the UE 402 with the radio bearer for additionally communicating with SCell 454 in CA. For example, PCell 404 may transmit a radio resource control (RRC) connection reconfiguration message to the UE 402 including one or more parameters to cause the UE to establish another radio bearer with SCell 454. PCell 404 can configure the SCell 454 for the UE 402 in CA such that the PCell 404 can aggregate communications to the UE 402 over PCell 404 and SCell 454 (e.g., by providing data to the SCell 454 for communicating to UE 402). In an example, communicating component 361 can receive the RRC connection reconfiguration message from the PCell 404 (e.g., via transceiver 406) and can accordingly establish the additional radio bearer with SCell 454 based on the one or more parameters for additionally communicating therewith. For example, the UE 402 may communicate with the SCell 454 to receive downlink communications therefrom concurrently with downlink communications from PCell 404 in CA.

Method 500 may also include, at Block 504, activating a CC with the SCell based at least in part on receiving a control element indicating to activate the CC for the radio bearer. In an aspect, CC activating/deactivating component 410, e.g., in conjunction with the one or more processors 403, memory 405, and/or transceiver 406, can activate the CC with the SCell 454 based at least in part on receiving a control element indicating to activate the CC for the radio bearer. In an example, communicating component 361 may receive the control element as a MAC CE over a radio bearer from PCell 404 or SCell 454, which indicates to activate the CC with SCell 454. For example, PCell 404 may determine to activate the SCell 454 for UE 402 based on one or more parameters of the UE 402 (e.g., a buffer status report received from the UE 402, measured signal quality of the SCell 454 received from the UE 402, etc.), one or more parameters of the PCell 404 (e.g., loading parameters or other channel availability considerations, etc.), a request (e.g., including the one or more parameters of the UE 402) from the UE 402 to activate the SCell 454, etc. to aggregate communications to the UE 402 over PCell 404 and SCell 454.

Moreover, in a specific example, CC activating/deactivating component 410 may activate the CC with a LTE-U SCell that communicates in an unlicensed frequency spectrum, and follows an adaptive transmission cycle, such as CSAT, to determine one or more time periods for activating radio resources of the UE 402 (e.g., transceiver 406 and/or related components). In one example, PCell 404 and/or SCell 454 can determine the CSAT cycle for the UE 402 (e.g., based on estimating a utilization of the medium by other devices, such as other LTE-U devices, Wi-Fi devices, etc., receiving an indication of the medium utilization from one or more devices, etc.). In another example, PCell 404 and/or SCell 454 can communicate CSAT cycle parameters (e.g., CSAT ON duration and/or CSAT OFF duration) to the UE 402, and the UE 402 can accordingly operate using CSAT to determine time periods for communicating with the SCell 454 (and/or PCell 404).

For example, PCell 404 and/or SCell 454 can communicate MAC CEs to the UE 402 for activating/deactivating a related CC, parameters corresponding to time periods when UE 402 can activate/deactivate the CC, etc. In this specific example, the SCell 454 may send MAC CEs for activating the CC based on determining a start of the CSAT ON duration and/or MAC CEs for deactivating the CC based on determining a start of the CSAT OFF duration (e.g., and/or based on an offset of start of the CSAT ON/OFF durations). In another example, SCell 454 may determine the CSAT cycle parameters (e.g., CSAT ON/OFF durations), and may effectively operate the CSAT cycle for the UE 402 by activating/deactivating the CC for the SCell using related MAC CEs. In either case, in this specific example, if communicating component 361 does not receive a MAC CE sent to deactivate the CC of the SCell, communicating component 361 may remain in a CSAT ON period, though the SCell is deactivated, which can unnecessarily consume power at the UE 402. This may occur, for example, where the UE 402 is in poor channel conditions and may not receive or be able to decode the MAC CE for deactivating the CC. In another example, UE 402 may be a single subscriber identity module (SIM) or multi-SIM UE, and in the latter case, may tune away to other RATs to monitor incoming signals for the UE 402 (e.g., pages for voice calls, short message service (SMS) messages, etc.), signals related to system acquisition or other signaling procedures, etc. on other RATs (e.g., to 1×round trip time (RTT), GSM, TD-SCDMA, or other RATs), where the current PCell RAT is LTE, for example, which may cause the UE 402 to miss the MAC CE for deactivating the CC of the SCell.

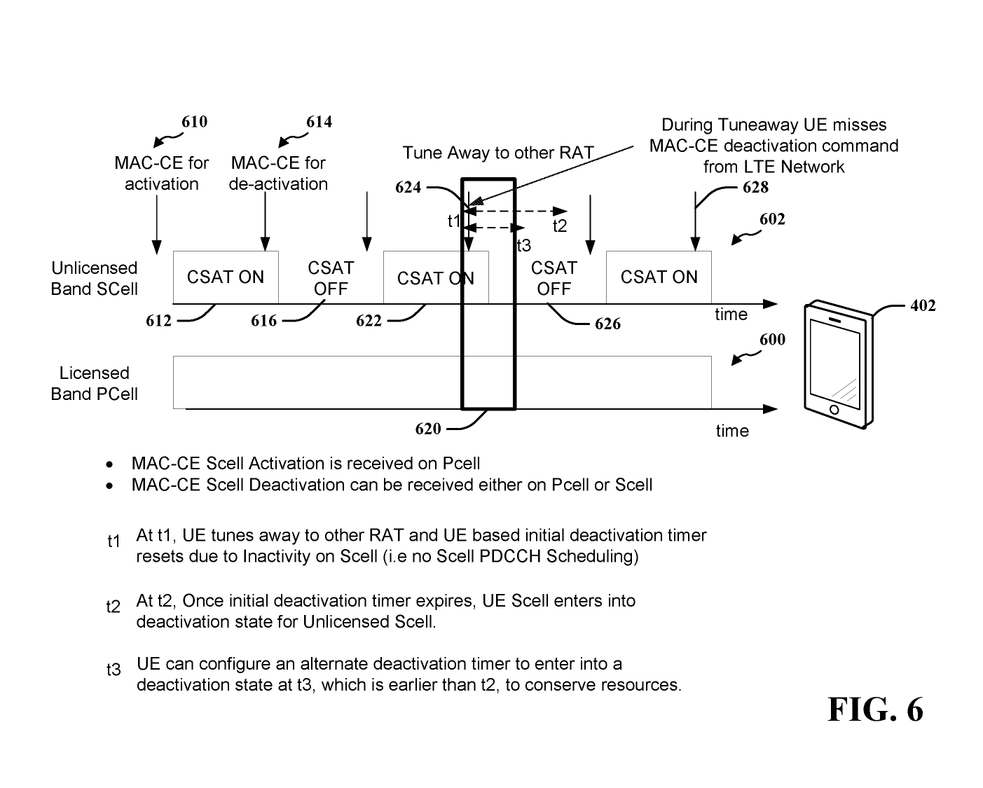

An example is illustrated in FIG. 6, which illustrates a UE 402 communicating with a licensed band PCell (e.g., LTE PCell) in timeline 600 and contemporaneously with an unlicensed band SCell (e.g., LTE-U SCell) in timeline 602. Accordingly, UE 402 communicates with the unlicensed band SCell in timeline 602 based on a CSAT cycle, which can be operated in conjunction with MAC CEs indicating to activate/deactivate the SCell CC. For example, UE 402 can receive a MAC CE 610 for activating the CC, which may be received from the PCell or SCell, as described (e.g., over corresponding radio bearers). CC activating/deactivating component 410 can accordingly activate the SCell CC, which may include or otherwise be related to UE 402 transitioning to a CSAT ON period 612. Similarly, for example, UE 402 can receive a MAC CE 614 for deactivating the SCell CC, which may be received over a radio bearer established with the SCell, as described. CC activating/deactivating component 410 can deactivate the SCell CC, which may include or otherwise be related to UE 402 transitioning to a CSAT OFF period 616.

During CSAT ON period 622, UE 402 may tune away its transceiver 406 for a duration 620 (e.g., for measuring cells on another frequency (e.g., cells of another RAT), performing other signaling procedures on other RATs, etc., as described). In any case, the SCell (or PCell) may transmit a MAC CE 624 for deactivating the CC of the SCell during the duration 620 when UE 402 is tuned away, and thus UE 402 may not receive the MAC CE 624. UE 402 may accordingly remain in the CSAT ON period 622 until the next MAC CE 628 for deactivating the SCell CC is received or until an initial deactivation timer expires, which can result in UE 402 unnecessarily consuming resources to monitor a control channel, transmit CSI, etc. in CSAT OFF period 626. In one example, PCell may configure the initial deactivation timer 416 for the UE 402 to deactivate the CC related to SCell, but this period of time may be of an undesirably long duration (such that using a smaller duration timer may result in less unnecessary consumption of resources at the UE 402).

Referring back to FIG. 5, in determining whether to configure a second deactivation timer (e.g., alternatively to a possibly initially configured deactivation timer, referred to herein as a “first activation timer” or “initial deactivation timer”), method 500 can include, at Block 506, determining whether a first deactivation timer is configured by the PCell. In an aspect, deactivation timer configuring component 412, e.g., in conjunction with the one or more processors 403 and/or memory 405, may determine whether the first deactivation timer (e.g., initial deactivation timer 416) is configured by the PCell 404. For example, deactivation timer configuring component 412 can determine whether a configuration received from PCell 404 includes a duration value for the initial deactivation timer 416. In a specific example, the initial deactivation timer 416 can include an SCellDeactivationTimer defined in LTE, which may be configured by PCell 404 with a configured duration of 20 milliseconds (ms), 40 ms, 80 ms, 160 ms, 320 ms, 640 ms, or 1280 ms based on LTE specifications.

If it is determined that the first deactivation timer is configured by the PCell at Block 506, method 500 can include, at Block 508, determining whether a configured duration of the first deactivation timer achieves a threshold. In an aspect, deactivation timer configuring component 412, e.g., in conjunction with the one or more processors 403 and/or memory 405, may determine whether the configured duration of the first deactivation timer (e.g., initial deactivation timer 416) achieves the threshold. As described, for example, the threshold may relate to a time for detecting inactivity over the SCell after which further consumption of resources by the UE is not desired. In a specific example, the threshold can be a value of a configured duration of the second deactivation timer (e.g., alternate deactivation timer 414), which deactivation timer configuring component 412 may configure as an alternative to the possibly configured initial deactivation timer 416 (e.g., if the initial deactivation timer 416 achieves the threshold). In this example, determining whether the configured duration of the first deactivation timer achieves the threshold can include comparing the configured duration of the first deactivation timer (e.g., initial deactivation timer 416) to a configured duration of the second deactivation timer (e.g., alternate deactivation timer 414) to determine whether the configured duration of the first deactivation timer is greater than the configured duration of the second deactivation timer.

In addition, for example, the threshold can be a value configured at the UE 402 (e.g., in memory 405), which can include a value hardcoded in the UE 402, a value configured on a SIM of the UE 402, a value received in a network configuration at the UE 402, etc. Moreover, in an example, deactivation timer configuring component 412 can determine whether a configured duration of the initial deactivation timer 416 (if configured) plus an offset achieves the threshold. For example, the offset can be configured at the UE 402 (e.g., in memory 405), which can include a value hardcoded in the UE 402, a value in a SIM of the UE 402, a value otherwise configured for the UE 402, etc. In an example, the offset may relate to an estimated time it may take for the PCell 404 (or related network) to detect that the SCell 454 is in discontinuous transmit mode (DTX) based on not receiving HARQ feedback from the UE 402 for transmissions by the SCell 454. As such, for example, the offset compensates for the network possibly detecting the SCell is in DTX based on not receiving feedback from the UE for SCell transmissions. Thus, adding the offset to the configured duration of the first deactivation timer can indicate an effective time for deactivation of the SCell at the PCell based on the initial deactivation timer as managed by the PCell.

In any case, if it is determined that the configured duration of first deactivation timer (plus the offset or otherwise) does not achieve the threshold at Block 508, method 500 may include, at Block 510, deactivating the CC with the SCell based at least in part on detecting expiration of the first deactivation timer before detecting communication related to the SCell. In an aspect, CC activating/deactivating component 410, e.g., in conjunction with the one or more processors 403, memory 405, and/or transceiver 406, may deactivate the CC with the SCell based at least in part on detecting expiration of the first deactivation timer (e.g., initial deactivation timer 416) before detecting communication related to the SCell 454. For example, CC activating/deactivating component 410 can reset the initial deactivation timer 416 when activity is detected with SCell 454 (e.g., communications received over the related CC), but may deactivate the CC if the initial deactivation timer 416 expires during a period of inactivity corresponding to the duration of the initial deactivation timer 416.

If it is determined that the first deactivation timer is not configured by the PCell at 506 and/or that the first deactivation timer (plus the offset or otherwise) achieves the threshold at Block 508, method 500 may include, at Block 512, configuring a second deactivation timer for deactivating the CC with the SCell. In an aspect, deactivation timer configuring component 412, e.g., in conjunction with the one or more processors 403 and/or memory 405, may configure the second deactivation timer (e.g., alternate deactivation timer 414) for deactivating the CC with the SCell when the first deactivation timer is not configured or when a configured duration of the first deactivation timer (plus the offset or otherwise) does achieve (e.g., has an expiry after the second deactivation timer) the threshold. As described, deactivation timer configuring component 412 of the UE 402 can configure the alternate deactivation timer 414 as an alternate to the initial deactivation timer 416 where the initial deactivation timer 416 is not configured and/or is of a configured duration (plus an offset or otherwise) that achieves a threshold (e.g., where the threshold may be a duration of the alternate deactivation timer 414). In other words, for example, deactivation timer configuring component 412 can configure the alternate deactivation timer 414 to be of a duration that is the minimum of a configured duration for the duration of the alternate deactivation timer 414 or a configured duration of the initial deactivation timer 416 plus the offset. In another example, if the configured duration of the initial deactivation timer 416 (e.g., plus the offset) is less than the configured duration of the alternate deactivation timer 414, deactivation timer configuring component 412 may not configure alternate deactivation timer 414 or may otherwise manage deactivation of the CC based on the initial deactivation timer 416.

Moreover, configuring the second deactivation timer at Block 512 may optionally include, at Block 514, determining a duration for the second deactivation timer based on a UE configuration. In an aspect, deactivation timer configuring component 412, e.g., in conjunction with the one or more processors 403 and/or memory 405, may determine the duration for the second deactivation timer (e.g., alternate deactivation timer 414) based on the UE configuration. For example, UE 402 may store a configuration (e.g., in memory 405) including a default value for the alternate deactivation timer 414, which may be 320 ms in one example where this time is deemed to allow sufficient time to tune away from the SCell 454, tune back to the SCell 454, and determine that the SCell 454 is likely deactivated based on determined inactivity. Thus, in one example, in configuring the alternate deactivation timer 414, deactivation timer configuring component 412 can configure the alternate deactivation timer 414 to be of a duration corresponding to the default value (e.g., 320 ms) and/or as a minimum of the default value or the duration of the initial deactivation timer 416 plus the offset.

Where the second deactivation timer is configured, method 500 may also include, at Block 516, deactivating the CC with the SCell based at least in part on detecting expiration of the second deactivation timer before detecting communication related to the SCell. In an aspect, CC activating/deactivating component 410, e.g., in conjunction with the one or more processors 403, memory 405, and/or transceiver 406, may deactivate the CC with the SCell 454 based at least in part on detecting expiration of the second deactivation timer (e.g., alternate deactivation timer 414) before detecting communication related to the SCell. For example, CC activating/deactivating component 410 can reset the alternate deactivation timer 414 when activity is detected with SCell 454 (e.g., communications received over the related CC), but may deactivate the CC if the alternate deactivation timer 414 expires during a period of inactivity corresponding to the duration of the initial deactivation timer 416. Configuring the alternate deactivation timer 414 in this regard at the UE 402 allows the UE 402 to control deactivation of the CC corresponding to the SCell, at least where the SCell is LTE-U, to prevent unnecessary CSAT ON periods at the UE 402.

Referring again to FIG. 6, the UE 402 can configure the alternate deactivation timer 414 to a value to cause deactivation of the SCell CC after detecting a period of inactivity for the duration of the alternate deactivation timer 414, corresponding to the time interval between time t1 and t3, which is less than the time interval between t1 and t2. Accordingly, UE 402 can conserve resources by deactivating the SCell CC sooner based on the alternative deactivation timer 414. In an example, UE 402 may configure the alternate deactivation timer 414 based on determining that a configured duration for the initial deactivation timer achieves the threshold or is greater than the configured duration for the alternate deactivation timer 414, that a configured duration for the initial deactivation timer plus a configured offset achieves the threshold, etc.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described herein that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method for deactivating a secondary cell (SCell) in carrier aggregation, comprising:
receiving, by a user equipment (UE), a configuration for a radio bearer with an SCell in a radio resource control (RRC) reconfiguration procedure initiated by a primary cell (PCell) serving the UE;
activating a component carrier with the SCell based at least in part on receiving a control element indicating to activate the component carrier for the radio bearer;
determining whether a first deactivation timer, for deactivating the component carrier with the SCell after a period of detected inactivity on the SCell, is configured by the PCell;
configuring a second deactivation timer for deactivating the component carrier with the SCell based at least in part on at least one of a first determination that the first deactivation timer is not configured by the PCell, or a second determination that a first configured duration of the first deactivation timer achieves a threshold; and
deactivating the component carrier with the SCell based at least in part on detecting an expiration of the second deactivation timer before detecting communication related to the SCell.

2. The method of claim 1, further comprising determining a second configured duration for the second deactivation timer based at least in part on a configuration stored at the UE, wherein configuring the second deactivation timer is based on the second configured duration.

3. The method of claim 1, further comprising receiving the first configured duration of the first deactivation timer from the PCell.

4. The method of claim 3, further comprising adding an offset value to the first configured duration of the first deactivation timer for the second determination that the first deactivation timer achieves the threshold, wherein the offset value compensates for a network detecting the SCell is in discontinuous transmit mode based on not receiving feedback from the UE for SCell transmissions.

5. The method of claim 4, further comprising determining the offset value based at least in part on a configuration stored at the UE.

6. The method of claim 1, wherein the threshold corresponds to a second configured duration of the second deactivation timer.

7. The method of claim 1, further comprising setting a second configured duration of the second deactivation timer to a default value configured at the UE based at least in part on determining that the second configured duration for the second deactivation timer is not configured at the UE.

8. An apparatus for deactivating a secondary cell (SCell) in carrier aggregation, comprising:
a transceiver for communicating one or more wireless signals over one or more antennas;
at least one processor communicatively coupled with the transceiver, via a bus, for communicating the one or more wireless signals; and
a memory communicatively coupled with the at least one processor and/or the transceiver via the bus;
wherein the at least one processor is configured to:
receive a configuration for a radio bearer with an SCell in a radio resource control (RRC) reconfiguration procedure initiated by a primary cell (PCell);
activate a component carrier with the SCell based at least in part on receiving a control element indicating to activate the component carrier for the radio bearer;
determine whether a first deactivation timer, for deactivating the component carrier with the SCell after a period of detected inactivity on the SCell, is configured by the PCell;
configure a second deactivation timer for deactivating the component carrier with the SCell based at least in part on at least one of a first determination that the first deactivation timer is not configured by the PCell or a second determination that a first configured duration of the first deactivation timer achieves a threshold; and
deactivate the component carrier with the SCell based at least in part on an detecting expiration of the second deactivation timer before detecting communication related to the SCell.

9. The apparatus of claim 8, wherein the at least one processor is further configured to determine a second configured duration for the second deactivation timer based at least in part on a configuration, wherein the at least one processor is configured to configure the second deactivation timer is based on the second configured duration.

10. The apparatus of claim 8, wherein the at least one processor is further configured to receive the first configured duration of the first deactivation timer from the PCell.

11. The apparatus of claim 10, wherein the at least one processor is further configured to add an offset value to the first configured duration of the first deactivation timer for the second determination that the first deactivation timer achieves the threshold, wherein the offset value compensates for a network detecting the SCell is in discontinuous transmit mode based on not receiving feedback for SCell transmissions.

12. The apparatus of claim 11, wherein the at least one processor is further configured to determine the offset value based at least in part on a stored configuration.

13. The apparatus of claim 8, wherein the threshold corresponds to a second configured duration of the second deactivation timer.

14. The apparatus of claim 8, wherein the at least one processor is further configured to set a second configured duration of the second deactivation timer to a default value configured based at least in part on determining that the second configured duration for the second deactivation timer is not configured.

15. An apparatus for deactivating a secondary cell (SCell) in carrier aggregation, comprising:
means for receiving a configuration for a radio bearer with an SCell in a radio resource control (RRC) reconfiguration procedure initiated by a primary cell (PCell);
means for activating a component carrier with the SCell based at least in part on receiving a control element indicating to activate the component carrier for the radio bearer;
means for determining whether a first deactivation timer, for deactivating the component carrier with the SCell after a period of detected inactivity on the SCell, is configured by the PCell;
means for configuring a second deactivation timer for deactivating the component carrier with the SCell based at least in part on at least one of a first determination that the first deactivation timer is not configured by the PCell or a second determination that a first configured duration of the first deactivation timer achieves a threshold; and
means for deactivating the component carrier with the SCell based at least in part on detecting an expiration of the second deactivation timer before detecting communication related to the SCell.

16. The apparatus of claim 15, further comprising means for determining a second configured duration for the second deactivation timer based at least in part on a configuration, wherein the means for configuring configures the second deactivation timer is based on the second configured duration.

17. The apparatus of claim 15, further comprising means for receiving the first configured duration of the first deactivation timer from the PCell.

18. The apparatus of claim 17, further comprising means for adding an offset value to the first configured duration of the first deactivation timer for the second determination that the first deactivation timer achieves the threshold, wherein the offset value compensates for a network detecting the SCell is in discontinuous transmit mode based on not receiving feedback for SCell transmissions.

19. The apparatus of claim 18, further comprising means for determining the offset value based at least in part on a stored configuration.

20. The apparatus of claim 15, wherein the threshold corresponds to a second configured duration of the second deactivation timer.

21. The apparatus of claim 15, further comprising means for setting a second configured duration of the second deactivation timer to a default value configured based at least in part on determining that the second configured duration for the second deactivation timer is not configured.

22. A computer-readable storage medium comprising computer executable code for deactivating a secondary cell (SCell) in carrier aggregation, the code comprising:
code for receiving, by a user equipment (UE) a configuration for a radio bearer with an SCell in a radio resource control (RRC) reconfiguration procedure initiated by a primary cell (PCell) serving the UE;
code for activating a component carrier with the SCell based at least in part on receiving a control element indicating to activate the component carrier for the radio bearer;
code for determining whether a first deactivation timer, for deactivating the component carrier with the SCell after a period of detected inactivity on the SCell, is configured by the PCell;
code for configuring a second deactivation timer for deactivating the component carrier with the SCell based at least in part on at least one of a first determination that the first deactivation timer is not configured by the PCell or a second determination that a first configured duration of the first deactivation timer achieves a threshold; and
code for deactivating the component carrier with the SCell based at least in part on detecting an expiration of the second deactivation timer before detecting communication related to the SCell.

23. The computer-readable storage medium of claim 22, further comprising code for determining a second configured duration for the second deactivation timer based at least in part on a configuration stored at the UE, wherein the code for configuring configures the second deactivation timer is based on the second configured duration.

24. The computer-readable storage medium of claim 22, further comprising code for receiving the first configured duration of the first deactivation timer from the PCell.

25. The computer-readable storage medium of claim 24, further comprising code for adding an offset value to the first configured duration of the first deactivation timer for the second determination that the first deactivation timer achieves the threshold, wherein the offset value compensates for a network detecting the SCell is in discontinuous transmit mode based on not receiving feedback from the UE for SCell transmissions.

26. The computer-readable storage medium of claim 25, further comprising code for determining the offset value based at least in part on a configuration stored at the UE.

27. The computer-readable storage medium of claim 22, wherein the threshold corresponds to a second configured duration of the second deactivation timer.

28. The computer-readable storage medium of claim 22, further comprising code for setting a second configured duration of the second deactivation timer to a default value configured at the UE based at least in part on determining that the second configured duration for the second deactivation timer is not configured at the UE.
